(19) United States
(12) Patent Application Publication
(10) Pub. No.: US 2025/0232657 A1
(43) Pub. Date: Jul. 17, 2025

(54) PET ALARM SYSTEM WITH WIRELESS COMMUNICATIONS

(71) Applicant: RESCUE RETRIEVER LLC, Gilbert, AZ (US)

(72) Inventor: Rusty TUSSING, Gilbert, AZ (US)

(21) Appl. No.: 18/410,119

(22) Filed: Jan. 11, 2024

(51) Int. Cl. G08B 17/10; A01K 27/00; G08B 5/36; G08B 25/00

(52) U.S. Cl. CPC G08B 17/10; A01K 27/001; G08B 5/36; G08B 25/00

(57) ABSTRACT

A wireless communication system that may include one or more of a smoke detector, a pet collar, a stand-alone camera, a microchip implant, and/or a firefighter alert device. The smoke detector may be configured to automatically send a fire alert signal to pet collar(s), user device(s) and/or firefighter alert device(s). The pet collar(s) may automatically turn on a plurality of collar light emitting diodes, the user device(s) may notify the owner of the smoke detection and the fire alert signal may let a firefighter know of possible pets, number of pets and or pet locations.

### TECHNICAL FIELD

This application relates to a wireless pet alarm system that may include an integrated smoke alarm, dog collar, camera, microchip implant, firefighter alert device and/or a user device.

### BACKGROUND

Pets typically reside in the same home as their owners. Fires in homes are a threat to not only the people, but also to the pets living in the home. Firefighters and other emergency responders try to save the people and the pets living in the home on fire. However, firefighters often don't know if any pets live in the home and, if pets do live in the home, where the pet is located. Limited visibility due to smoke and many pets' inability to cry out for help may greatly hinder firefights' ability to save the pets in the home.

Smoke detectors may detect fires by sensing small particles in the air. Once the smoke detector detects these particles above a certain level, the smoke detector may signal an alarm to warn people of a possible fire. Ionization-type smoke detectors have a small amount of radioactive material between two electrically charged plates, which ionizes the air and causes current to flow between the plates. When smoke enters the chamber, it disrupts the flow of ions, thus reducing the flow of current and activating the alarm. Photoelectric-type smoke detectors aim a light source into a sensing chamber at an angle away from the sensor. Smoke that enters the chamber reflects the light onto the light sensor, thereby triggering the alarm.

A dog collar is a piece of material put around the neck of a dog. The dog collar may be used for restraint, identification, fashion, or training.

A camera is a device that has a lightproof chamber with an aperture fitted with a lens through which an image of an object is projected onto a surface for recording or for translation into electrical impulses. A camera may also be paired with a motion sensor that detects motion within a small distance from the camera.

Microchip implants may be used for pets to provide a form of permanent identification. The microchip implants may be called radio frequency identification (RFID) tags. The microchip implants may be very small, about the size of a large grain of rice, and are passive. The microchip implants passively store a unique identification number and do not actively transmit any information. The microchip implant has no battery and no internal power source, but it sits inertly in the pet until the microchip implant is read by a microchip scanner.

### SUMMARY

The invention may include a smoke detector that may be used with the present invention. The smoke detector may be powered using the power lines to the home, batteries or the power to the home with batteries as a backup when the power to the home fails. The smoke detector may include a microprocessor, microcontroller or other programmable electronic devices and electronic memory that allow the smoke detector to be able to be configured to perform a variety of different functions automatically.

The smoke detector may include a built-in smoke detector camera and/or a built-in smoke detector motion sensor. The smoke detector camera and/or smoke detector motion detector may be configured to monitor the presence and/or a current location of one or more pets in the home.

The smoke detector may include a wireless communication unit. The smoke detector wireless communication unit may be able to communicate using any desired wireless protocol. As non-limiting examples, the wireless communication unit may be able to communicate with other wireless devices using a Bluetooth connection, a cellular network, a home Wi-Fi network or any combination thereof.

The smoke detector may be configured to automatically send from the smoke detector wireless communications unit a fire alert signal to one or more collars 200 of pets in the home when the smoke detection unit detects smoke, thereby triggering and enabling the collars 200 of the pets to take their own actions.

The smoke detector may be configured to automatically send from the smoke detector wireless communication unit a fire alert signal to a user device when the smoke detection unit detects smoke.

The smoke detector may be configured to automatically send from the smoke detector wireless communication unit a fire alert signal to a firefighter alert device. The firefighter alert device may be any electronic device that is able to receive the fire alert signal.

The invention may include a pet collar. The collar may be a strip of material configured to be placed around the neck of a pet. The collar may be made of any desired material. As non-limiting examples, the collar may be made of leather, nylon webbing, polyester and/or metal. The collar may also be waterproof to protect some of the features of the collar discussed below that might be damaged by water.

The collar may include a wireless communication unit. The collar wireless communication unit may be able to communicate using any desired wireless protocol. As non-limiting examples, the collar wireless communication unit may be able to communicate with other wireless devices using a Bluetooth connection, a cellular network, a home Wi-Fi network or any combination thereof.

The collar wireless communication unit may be able to receive a fire alert signal from the smoke detector. The fire alert signal may be used to automatically trigger any predetermined action by the collar desired by the owner. The collar may have a plurality of light emitting diodes attached to the strip of material of the collar at any desired location, in any desired pattern and in any desired number.

A microchip implant may be inserted under the skin of a pet. The microchip implant may be used to track the location of the animal using any desired method. As non-limiting examples, the microchip implant may provide real time tracking capabilities using mobile networks, star link or satellite systems. The microchip implant may communicate the tracking information to the user device or the firefighter alert device to locate the pet.

The stand-alone camera may include a stand-alone camera wireless communication unit, a camera and/or a motion sensor. The stand-alone camera may monitor a current location of a pet in the home and feed this information to the smoke detector and/or firefighter alert device.

The user device may be any electronic device that is able to receive the fire alert signal and run an application. As non-limiting examples, the user device may be one or more cell phones, laptops, electronic displays and/or computers of the pet owners and/or the homeowners. The application running on the user device may track all information collected and transmitted by the smoke detector, the collar, the stand-alone camera, the microchip implant, pet doors and/or the firefighter alert device.

The smoke detector, pet collar, stand-alone camera, microchip implant and firefighter alert device may each communicate directly with each other, through any desired wireless communication network or a combination of communicating directly and through a wireless communication network.

Further aspects and embodiments are provided in the foregoing drawings, detailed description, and claims.

### BRIEF DESCRIPTION OF THE DRAWINGS

FIG. 1 is an illustration of a perspective view of a smoke detector that may be used with the present invention.

FIG. 2 is an illustration of a perspective view of a pet collar that may be used with the present invention.

FIG. 3 is an illustration of a wireless communication system that may include the smoke detector from FIG. 1, the pet collar from FIG. 2, a stand-alone camera, a microchip implant, and/or a firefighter alert device.

### DETAILED DESCRIPTION

The following description recites various aspects and embodiments of the inventions disclosed herein. No particular invention is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly indicates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only to aid in understanding embodiments illustrated in the present disclosure and are not meant to be limiting in any fashion. Nor do these phrases indicate any kind of preference for the disclosed embodiment.

As used herein, “automatically” means that after a device is powered on and set-up as desired by a human, the device is able to take certain actions on its own without further human intervention.

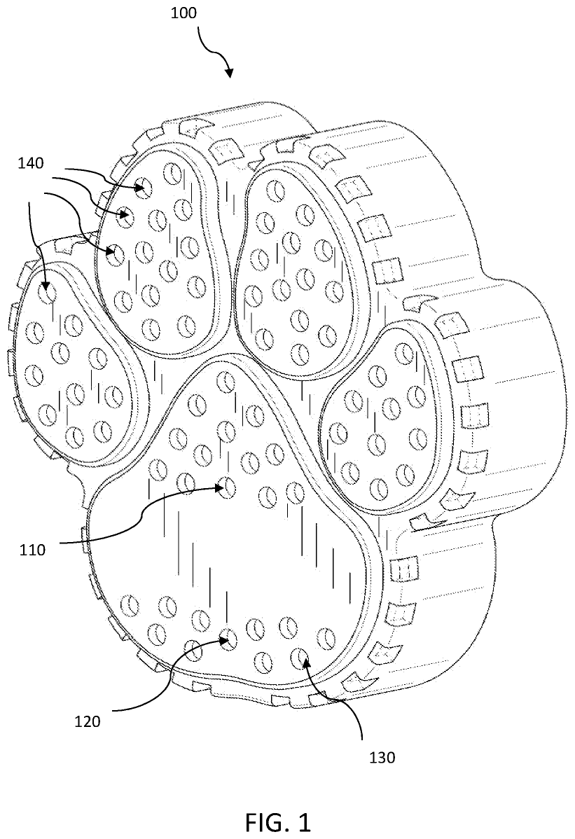

FIG. 1 is an illustration of a perspective view of a smoke detector 100 that may be used with the present invention. The smoke detector 100 may be powered using the power lines to the home, batteries or the power to the home with batteries as a backup when the power to the home fails. The smoke detector 100 may include a microprocessor, microcontroller or other programmable electronic devices and electronic memory that allow the smoke detector 100 to be able to be configured to perform a variety of different functions automatically as described below. The smoke detector 100 may be mounted in any desired place in the house. As non-limiting examples, the smoke detector 100 may be mounted on a bed, wall, window or door.

The smoke detector 100 may include a smoke detection unit that may detect smoke by any desired means. The smoke detector 100 may include a smoke chamber 120 to detect carbon monoxide. As non-limiting examples, the smoke detection unit may be an ionization-type smoke detector or a photoelectric-type smoke detector. When smoke is detected, the smoke detector 100 may have a sound unit that emits a loud sound warning those in the home of a possible fire.

The smoke detector 100 may include a built-in smoke detector camera 110 and/or a built-in smoke detector motion detector 130. The built-in smoke detector camera 110 and/or the built-in smoke detector motion detector 130 may be configured to monitor the presence and/or a current location of one or more pets in the home.

The smoke detector 100 may include a wireless communication unit. The smoke detector wireless communication unit may be able to communicate using any desired wireless protocol. As non-limiting examples, the wireless communication unit may be able to communicate with other wireless devices using a Bluetooth connection, a cellular network, a home Wi-Fi network or any combination thereof.

The smoke detector 100 may be configured to automatically send from the smoke detector wireless communications unit a fire alert signal to one or more collars 200 of pets in the home when the smoke detection unit detects smoke, thereby triggering and enabling the collars 200 of the pets to take their own actions.

The smoke detector 100 may be configured to automatically send from the smoke detector wireless communication unit a fire alert signal to a user device when the smoke detection unit detects smoke.

The smoke detector 100 may be configured to automatically send from the smoke detector wireless communication unit a fire alert signal to a firefighter alert device 350. The firefighter alert device 350 may be any electronic device that is able to receive the fire alert signal. As non-limiting examples, the firefighter alert device 350 may be a cell phone, firefighter helmet, laptops, electronic displays, audio notification systems, heads-up-display provided by their firefighter equipment or any other small computer devices.

The fire alert signal sent from the smoke detector 100 may comprise any desired information. As non-limiting examples, the fire alert signal may include a number of pets in the home, a location of the pets in the home and/or a location of a fire in the home.

The smoke detector 100 may include a plurality of light emitting diodes 140 attached to the outer surface of the smoke detector 100 at any desired location, in any desired pattern and in any desired number. When no smoke is detected, the plurality of light emitting diodes 140 may be off or have a calm mood lighting effect.

In a preferred embodiment, the plurality of light emitting diodes 140 may be configured to turn on in a predetermined pattern, a predetermined color and/or a predetermined strobe effect as desired when the smoke detection unit detects smoke. As a non-limiting example, the plurality of light emitting diodes 140 may flash red once every second when the smoke detection unit detects smoke.

The plurality of light emitting diodes 140 may also create a picture of a pet on a wall if a pet is in the home to alert a firefighter or other emergency responder of the presence of pets. The plurality of light emitting diodes 140 may create a picture of an arrow on a wall indicating a direction a pet is in the home to help the firefighter or other emergency responders locate a pet in the home. In some embodiments a picture of a pet followed by an arrow indicating the direction the pet is located may be displayed on a wall by the plurality of light emitting diodes 140 or other light emitting displays built into the smoke detector 100.

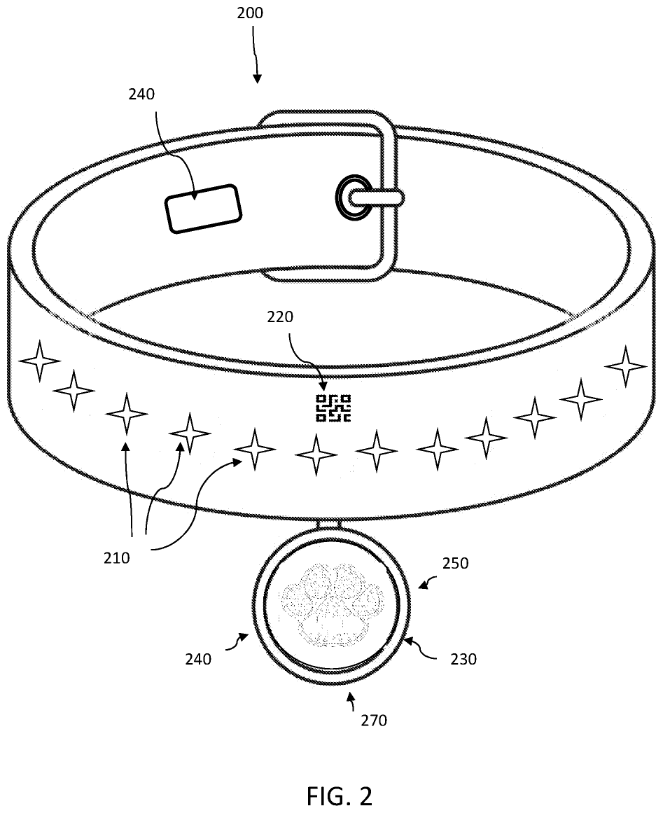

FIG. 2 is an illustration of a perspective view of a pet collar 200 that may be used with the present invention. The collar 200 may be a strip of material configured to be placed around the neck of a pet. The collar 200 may be made of any desired material. As non-limiting examples, the collar 200 may be made of leather, nylon webbing, polyester and/or metal. The collar 200 may also be waterproof to protect some of the features of the collar 200 discussed below that might be damaged by water. The collar 200 may include a tag 230. It should be appreciated that any device or capability attributed to the collar 200 may in some embodiments be on or performed by the tag 230.

The collar 200 may include a wireless communication unit. The collar wireless communication unit may be able to communicate using any desired wireless protocol. As non-limiting examples, the collar wireless communication unit may be able to communicate with other wireless devices using a Bluetooth connection, a cellular network, a home Wi-Fi network or any combination thereof.

The collar 200 may include a monitor sensor 240 integrated into the collar 200 that is configured to monitor one or more bio signals of a pet. The collar wireless communication unit may be able to wirelessly transmit the bio signals to a user device, thereby allowing the pet owner to be aware of the health of their pet. The bio signals may include a number of steps a pet has taken in a day, the time the pet has been active in the day, distance walked/ran, pulse/heart rate and breathes taken, calories burned and sleep stages.

The collar 200 may include a quick response (QR) code 220 printed on the collar 200. The QR code 220 may be printed on either the inside or outside surface of the collar 200. The QR code 220 may give contact information, such as a cell phone number and/or an address of the pet's owner to enable somebody who finds the pet to return the pet to their owner. The QR code 220 may also provide health information for the pet which may be used by a veterinarian.

The collar wireless communication unit may be able to receive a fire alert signal from the smoke detector 100. The fire alert signal may be used to automatically trigger any predetermined action by the collar 200 desired by the owner. The collar 200 may have a plurality of light emitting diodes 210 attached to the strip of material of the collar 200 at any desired location, in any desired pattern and in any desired number. When no fire alert signal has been received, the plurality of light emitting diodes 210 may be off or have a calm mood light effect. In some embodiments, the collar plurality of light emitting diodes 210 may display a color depending or based on a determined mood or health of the pet. As non-limiting examples, the collar plurality of lights may be red if the pet is in health distress or in an agitated state and green when the pet is healthy and/or calm based on one or more bio signals received from the collar integrated monitor sensor 240. The monitor sensor 240 may be located in the part of the collar 200 that goes around the neck of the pet or the monitor sensor 240 may be located in the tag 230 of the collar 200.

The collar plurality of light emitting diodes 210 may be configured to turn on in a predetermined pattern, a predetermined color and/or a predetermined strobe effect as desired when the collar 200 receives the fire alert signal from the smoke detector 100. As a non-limiting example, the collar plurality of light emitting diodes 210 may flash red once every second when the collar 200 receives the fire alert signal from the smoke detector 100.

The collar 200 may have a transmitter 270 integrated into the collar 200 that is configured to open a pet door when the transmitter 270 is within a first predetermined distance from the pet door and close the pet door when the transmitter 270 is not within a second predetermined distance from the pet door. The first predetermined distance and the second predetermined distance may be any desired distances. As a non-limiting example, the pet door may open when the pet is within five feet of the door and close when the pet is further away than 10 feet from the door. A signal may be transmitted from either the collar 200 or the pet doors to the user device 300 to notify the user that a dog door has been activated. A pet door is hereby defined to be any door the pet is allowed to open or close.

The collar transmitter 270 may also be configured to send a notification to a user device 300 if the collar 200 (and the attached pet) exceeds a predetermined distance from a point in the home. This provides notice to the owner of the pet that the pet may have left the home unexpectedly.

The collar 200 may include a moisture sensor 250 and the transmitter 270 may be configured to send a notification to a user device 300 if the moisture sensor 250 detects that the collar 200 (and attached dog) has gotten wet. This provides notice to the owner that the pet may have fallen into a pool.

A microchip implant 330 may be inserted under the skin of a pet. The microchip implant 330 may be used to track the location of the animal using any desired method. As non-limiting examples, the microchip implant 330 may provide real time tracking capabilities using mobile networks, star link or satellite systems. The microchip implant 330 may communicate the tracking information to the user device 300 or the firefighter alert device 350 to locate the pet.

The microchip implant 330 may also be able to provide owner contact information, pet name, breed, vaccination status, health allergies, current medications taken, QR code 220 identifier and health watch alerts. The microchip implant 330 may also be able to track steps taken, miles walked/ran, heart pulse rate, breathing rate, calories burned, sleep stages achieved and active minutes in a desired time period.

The stand-alone camera 340 may include a stand-alone camera wireless communication unit, a camera and/or a motion sensor. The stand-alone camera 340 may monitor a current location of a pet in the home and feed this information to the smoke detector 100 and/or firefighter alert device 350. The stand-alone camera 340 may be placed near a pool and detect if a pet is near the pool. A signal notification from the stand-alone camera 340 may be transmitted to the user device 300, notifying the owner that their pet is near the pool. A signal notification from the stand-alone camera 340 may be transmitted to the smoke detector 100, which may emit a sound and strobe the plurality of smoke detector plurality of light emitting diodes 140 in a preselected manner to warn that the detected pet is near the pool.

The user device 300 may be any electronic device that is able to receive the fire alert signal and run an application. As non-limiting examples, the user device 300 may be one or more cell phones, laptops, electronic displays and/or computers of the pet owners and/or the homeowners. The application running on the user device 300 may track all information collected and transmitted by the smoke detector 100, the collar 200, the stand-alone camera 340, the microchip implant 330, pet doors and/or the firefighter alert device 350. The application on the user device 300 may be used to monitor the health and location of the pets and provide corresponding historical data. The application running on the user device 300 may track and display on the user device 300 in real time the locations of the pet(s), real time health of the pet(s), activities of the pet(s), pet doors opened, closed and proximity breaches of the pet(s) and live video from either or both of the stand-alone camera 340 or the built-in smoke detector camera 110. The application running on the user device 300 may also integrate all the data collected by the smoke detector 100, the pet collar 200 (including at least the monitor sensor 240), the pet doors, the stand-alone camera 340, the microchip implant 330 and the firefighter alert device 350. The application may also provide reminders of pending scheduled veterinarian appointments to the pet owner.

The data collected and stored by the application may be any desired data. As non-limiting examples the application may collect and store data for the breed of the pet, name of the pet, name and contact information of the pet owner, vaccination status, medical history of the pet, allergies of the pet, medications taken by the pet, past and future scheduled veterinarian appointments and last known address for the pet.

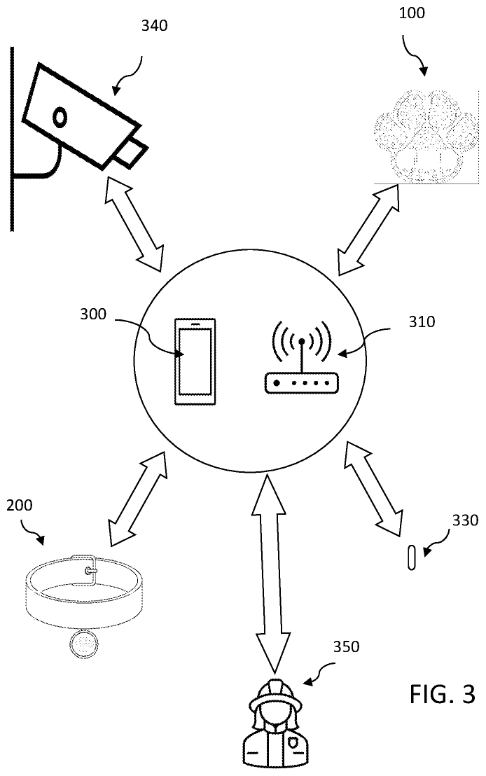

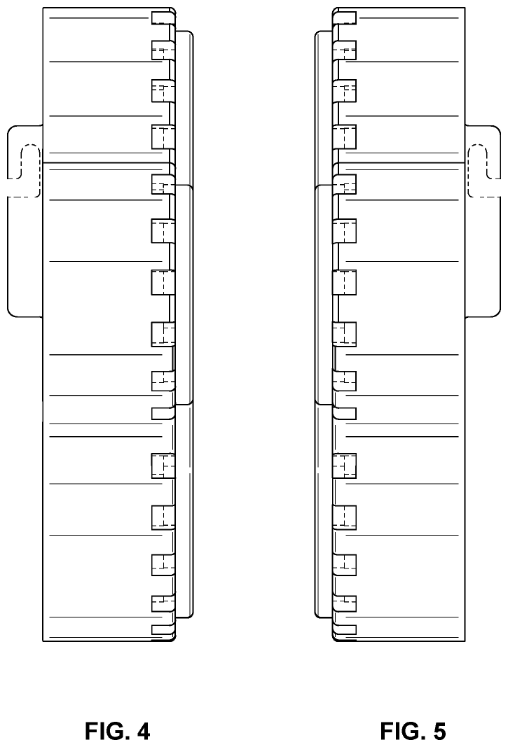

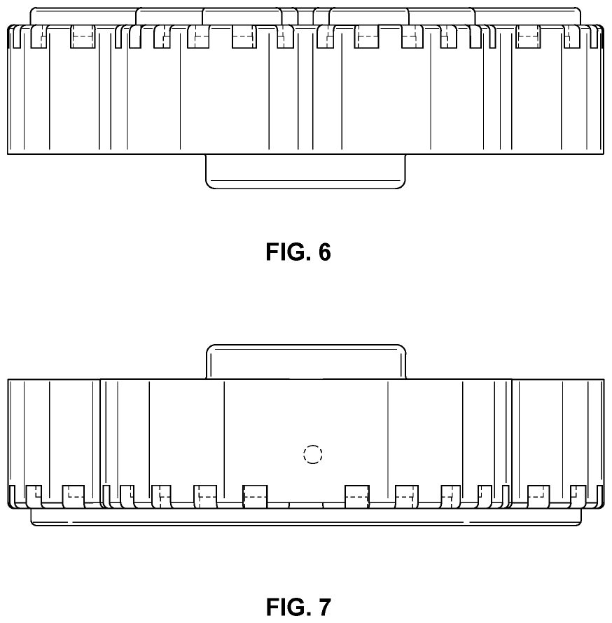

FIG. 3 is an illustration of a wireless communication system that may include the smoke detector 100 from FIG. 1, the pet collar 200 from FIG. 2, the stand-alone camera 340, the microchip implant 330, and/or the firefighter alert device 350. The invention may include any single illustrated device, any sub combination of illustrated devices, all of the illustrated devices or all of the illustrated devices working with other devices. The smoke detector 100, pet collar 200, stand-alone camera 340, microchip implant 330 and firefighter alert device 350 may each communicate directly with each other, through any desired wireless communication network 310 or a combination of communicating directly and through a wireless communication network 310.

The invention has been described with reference to various specific and preferred embodiments and techniques. Nevertheless, it is understood that many variations and modifications may be made while remaining within the spirit and scope of the invention.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A home pet protection system, comprising:
a smoke detector, comprising a smoke detection unit and a smoke detector wireless communication unit; and
a collar, comprising a strip of material, a plurality of light emitting diodes attached to the strip of material and a collar wireless communication unit, wherein the smoke detector and the collar are configured to be in wireless communication with each other.

2. The home pet protection system of claim 1, wherein the smoke detector is configured to automatically send from the smoke detector wireless communication unit a fire alert signal to the collar when the smoke detection unit detects smoke.

3. The home pet protection system of claim 2, wherein the light emitting diodes are configured to automatically turn on in a predetermined pattern when the collar receives the fire alert signal from the smoke detector.

4. The home pet protection system of claim 1, wherein the smoke detector further comprises a smoke detector camera and the smoke detector camera is configured to monitor a location of a pet in the home.

5. The home pet protection system of claim 1, further comprises a stand-alone camera, wherein the stand-alone camera comprising a stand-alone camera wireless communication unit and the stand-alone camera monitors a location of a pet in the home.

6. The home pet protection system of claim 1, wherein the smoke detector is configured to automatically send from the smoke detector wireless communications unit a fire alert signal to a user device when the smoke detection unit detects smoke.

7. The home pet protection system of claim 1, wherein the smoke detector is configured to automatically send from the smoke detector wireless communications unit a fire alert signal to a firefighter alert device when the smoke detection unit detects smoke.

8. The home pet protection system of claim 7, wherein the fire alert signal comprises a number of pets in the home.

9. The home pet protection system of claim 7, wherein the fire alert signal comprises a location of a pet in the home.

10. A smoke detector, comprising:
a smoke detection unit;
a smoke detector wireless communication unit; and
a plurality of light emitting diodes attached to the smoke detector, wherein the plurality of light emitting diodes attached to the smoke detector are configured to turn on in a predetermined pattern when the smoke detection unit detects smoke.

11. The smoke detector of claim 10, wherein the smoke detector is configured to automatically send from the smoke detector wireless communications unit a fire alert signal to a collar when the smoke detection unit detects smoke.

12. The smoke detector of claim 10, wherein the smoke detector further comprises a smoke detector camera and the smoke detector camera is configured to monitor a location of a pet in a home.

13. The smoke detector of claim 10, wherein the smoke detector is configured to automatically send from the smoke detector wireless communication unit a fire alert signal to a user device when the smoke detection unit detects smoke.

14. The smoke detector of claim 10, wherein the smoke detector is configured to automatically send from the smoke detector wireless communication unit a fire alert signal to a firefighter alert device.

15. The smoke detector of claim 14, wherein the fire alert signal comprises a number of pets in a home.

16. The smoke detector of claim 14, wherein the fire alert signal comprises a location of a pet in a home.

17. A collar, comprising:
a strip of material;
a plurality of light emitting diodes attached to the strip of material; and
a collar wireless communication unit, wherein the collar is configured to wireless communicate with a smoke detector.

18. The collar of claim 17, further comprising:
a monitor sensor integrated into the collar that is configured to monitor a bio signal of a pet and wirelessly transmit the bio signal to a user device.

19. The collar of claim 18, wherein the monitor sensor is configured to determine a mood of the pet and the plurality of light emitting diodes attached to the strip of material are configured to change colors depending on the determined mood of the pet.

20. The collar of claim 17, further comprising:
a transmitter integrated into the collar that is configured to open a pet door when the transmitter is within a first predetermined distance from the pet door and close the pet door when the transmitter is not within a second predetermined distance from the pet door.
